(19) United States
(12) Patent Application Publication
(10) Pub. No.: US 2026/0030096 A1
(43) Pub. Date: Jan. 29, 2026

(54) ERROR CONTROL FOR FUSE ARRAYS

(71) Applicant: Micron Technology, Inc., Boise, ID (US)

(72) Inventors: Thomas Hein, München (DE); Casto Salobrena Garcia, München (DE); Wolfgang Anton Spirkl, Germering (DE); Peter Mayer, Neubiberg (DE); Ronny Schneider, Höhenkirchen-Siegertsbrunn (DE)

(21) Appl. No.: 19/273,975

(22) Filed: Jul. 18, 2025

Related U.S. Application Data
(60) Provisional application No. 63/674,921, filed on Jul. 24, 2024.

(51) Int. Cl. G06F 11/10

(52) U.S. Cl. CPC G06F 11/1004

(57) ABSTRACT

Methods, systems, and devices for error control for fuse arrays are described. The described techniques may enable a memory system to perform error control on a fuse block. The fuse block may include one or more fuses that store error control information that is generated based on the control information stored in the corresponding fuse block. The memory system may therefore use the error control information to determine whether the fuse block contains an error and to correct one or more errors contained in the fuse block. In some examples, the memory system may output an error flag or update an error log when an error is detected. In some examples, each fuse block may include multiple sets of error control fuses, and a fuse selector may determine which set of error control fuses to use for error control of the fuse block.

### CROSS REFERENCE

The present application for patent claims priority to U.S. Patent Application No. 63/674,921 by Hein et al., entitled “ERROR CONTROL FOR FUSE ARRAYS,” filed Jul. 24, 2024, which is assigned to the assignee hereof, and which is expressly incorporated by reference in its entirety herein.

### TECHNICAL FIELD

The following relates to one or more systems for memory, including error control for fuse arrays.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports error control for fuse arrays in accordance with examples as disclosed herein.

FIG. 2 shows an example of a memory system diagram that supports error control for fuse arrays in accordance with examples as disclosed herein.

FIG. 3 shows an example of a memory system diagram that supports error control for fuse arrays in accordance with examples as disclosed herein.

FIG. 4 shows a block diagram of a memory system that supports error control for fuse arrays in accordance with examples as disclosed herein.

FIG. 5 shows a flowchart illustrating a method or methods that support error control for fuse arrays in accordance with examples as disclosed herein.

### DETAILED DESCRIPTION

In some memory systems, control information (e.g., one or more operating parameters) for a memory device may be stored in a non-volatile memory of the memory system, such as a fuse array. In some examples, one or more fuses of the fuse array may store information that includes an error. The fuse array may include backup fuses (sometimes referred as redundant fuses) corresponding to each fuse in the fuse block to protect the stored information for errors. For example, a fuse array may store multiple copies of the same control information. If the control information stored in a first set of fuses includes an error, the memory system may access a set of fuses that stores a duplicate of that control information. However, such techniques may use many additional fuses for each fuse block, which may increase the size of the fuse array. Storing duplicates of information, however, does not enable the memory system to detect errors in the stored information. In some cases, the error may not be detected, and the memory system may use information with errors. Such conditions may degrade the performance of the memory system or cause the memory system to fail. The backup fuse techniques may not enable error control (e.g., error detection and/or correction) for the fuse array. A user may therefore be unaware that the fuse array has an error, and the fuse array may have a relatively shorter lifespan due to uncorrectable errors.

Accordingly, techniques described herein may enable a fuse array to include one or more fuses that store error control information (e.g., parity information, cyclic redundancy check (CRC) information, or error correction code (ECC) information) associated with the information stored in the fuse array. For example, the error control information may include one or more bits that are generated based on the information stored in the corresponding fuse array. The memory system may therefore use the error control information to determine whether the information stored in the fuse error contains an error. In some examples, if the error control information includes ECC information, the memory system may be capable of correcting one or more errors (e.g., single-bit errors (SBEs)) contained in the information associated with the error control information. In some examples, the memory system may output an error flag and/or update an error log when an error is detected.

In some examples, the fuse array may enable post-package repair (PPR) in which a customer may remap information from a first set of fuses (that includes an error) to a second set of fuses of the fuse array. In addition to swapping a first set of fuses with a redundant set of fuses, one or more redundant fuses may be included in the fuse area to allow for PPR for fuses that store the error control information. Accordingly, each fuse array may include a first set of redundant fuses to store information and a second set redundant fuses to store error control information that is associated with the information. Muxes and other components may enable a memory system to swap the second set of redundant fuses with other fuses for error control information as part of a PPR procedure.

In addition to applicability in memory systems as described herein, techniques for error control for fuse arrays may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling error control (e.g., error detection and/or correction) for fuse arrays, which may decrease processing or latency times, improve response times, or otherwise improve user experience, among other benefits, by reducing a quantity of errors present in the fuse array.

In addition to applicability in memory systems as described herein, techniques for error control for fuse arrays may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by enabling error control (e.g., error detection and/or correction) for fuse arrays, which may extend the life of electronic devices and reduce a quantity of fuses in electronic devices, thereby reducing electronic waste, among other benefits, by reducing a quantity of errors present in the fuse array.

Features of the disclosure are illustrated and described in the context of systems and architectures. Features of the disclosure are further illustrated and described in the context of memory system diagrams and flowcharts.

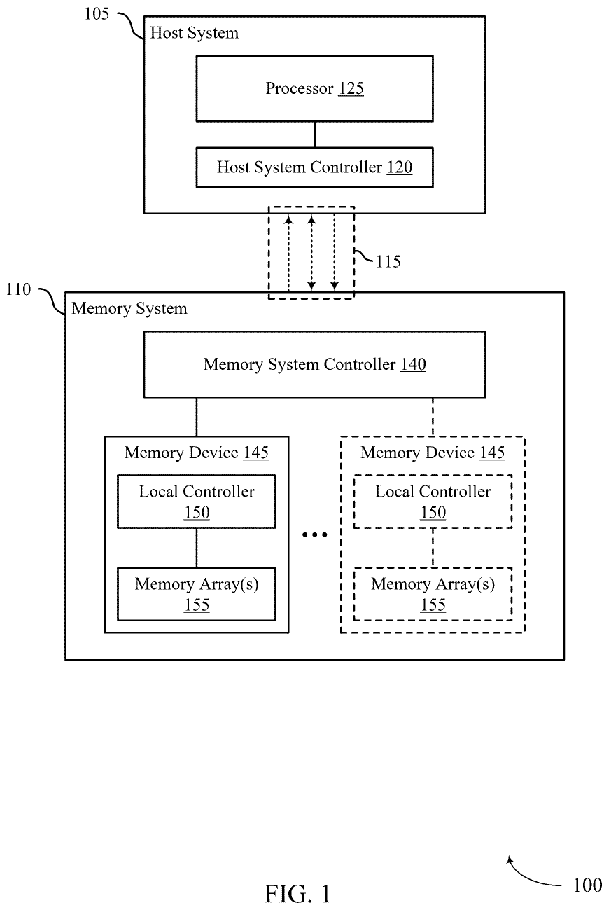

FIG. 1 illustrates an example of a system 100 that supports error control for fuse arrays in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, a memory system 110 may include a fuse array of one or more fuse blocks storing control information (e.g., operating parameters) for operating the memory system. The fuse array may include one or more fuses corresponding to each fuse block that store error control information (e.g., parity information, CRC information, or ECC information) for the corresponding fuse block. For example, the error control information may include one or more bits that are generated based on the control information stored in the corresponding fuse block. The memory system 110 may therefore use the error control information to determine whether the fuse block contains an error. In some examples, if the error control information includes ECC information, the memory system 110 may correct one or more errors (e.g., SBEs) contained in the fuse block. In some examples, the memory system 110 may output an error flag and/or update an error log when an error is detected. In some examples, the fuse array may include multiple sets of error control fuses corresponding to each fuse block, and a fuse selector may determine which set of error control fuses to use for error control of the fuse block.

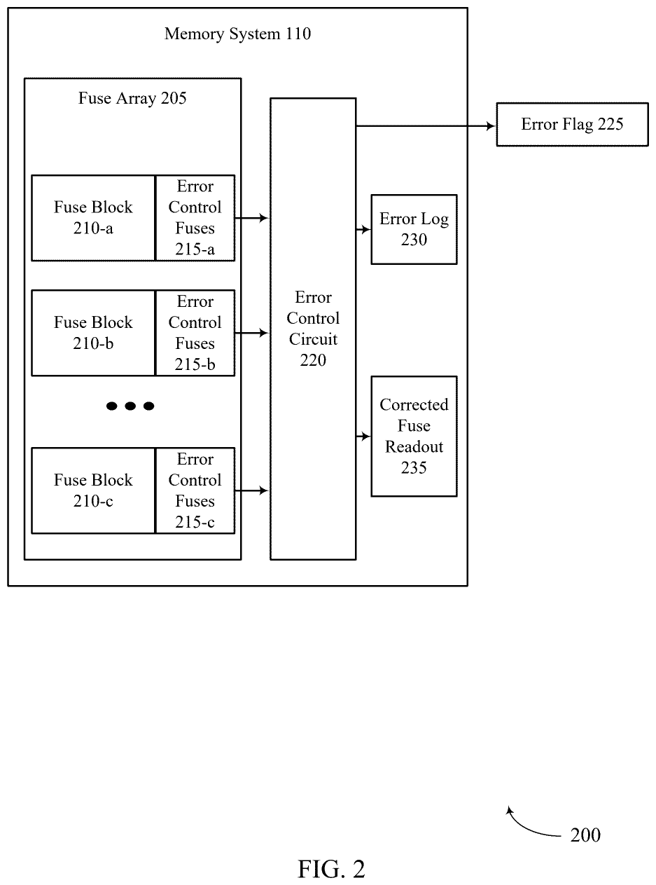

FIG. 2 shows an example of a memory system diagram 200 that supports error control for fuse arrays in accordance with examples as disclosed herein. The memory system diagram 200 may implement or may be implemented by aspects of the system 100. For example, the memory system diagram 200 may be implemented in the memory system 110 as described with reference to FIG. 1. The techniques described in the context of the memory system diagram 200 may enable a memory system 110 to detect and/or correct errors in a fuse array 205.

In some examples, a memory system 110 may include a fuse array 205 with one or more fuse blocks 210 (e.g., a fuse block 210-a, a fuse block 210-b, a fuse block 210-c). A fuse block 210 may be an example of a set of fuses configured to store information. A fuse block 210 may be way to divide a fuse array into sub-elements where specific information can be stored. The fuse blocks 210 may include fuses storing control information related to operating a memory device of the memory system 110. For example, the fuses may store operating parameters such as indicators to activate/deactivate error control functions, parameters related to on-die termination, parameters related to termination offsets, parameters related to refresh, threshold voltages for read operations, timings for various operations, or a combination thereof. The memory system 110 may read the control information from the fuse array 205 and may use the control information to operate a memory device.

The fuse array 205 is a non-volatile memory that is typically not writable, once written. Thus, if an error occurs in a fuse block 210 (e.g., the information stored in the fuse block 210 includes an error), that error may be permanent. In some examples, an error in a fuse block may prevent the memory system 110 from correctly operating the memory device. One technique to protect information stored in the fuse array 205 is to store multiple copies (e.g., two or more) of the information in the fuse array 205. However, such techniques may include a relatively large quantity of fuses, and may not enable the memory system 110 to perform error control (e.g., error detection and/or error correction).

Accordingly, the fuse array 205 may include a set of error control fuses 215 that enables error control operations to be applied to information stored in the fuse array 205. In some cases, a set of error control fuses 215 may be associated with each fuse block 210 and storing error control information for the corresponding fuse block 210. For example, the fuse block 210-a may correspond to error control fuses 215-a, the fuse block 210-b may correspond to error control fuses 215-b, and the fuse block 210-c may correspond to error control fuses 215-c. In some examples, the error control fuses 215 may store parity information, CRC information, and/or ECC information. As described herein, parity information may be an example of a bit that acts as a check on a set of binary values (e.g., values stored in the fuse block 210). CRC information may be an example of a set of values designed to detect errors in data (e.g., data stored in the fuse block 210). ECC information may be an example of a set of values designed to detect and/or correct errors in data (e.g., data stored in the fuse block 210). The error control information may be generated (e.g., by the memory system 110, during manufacturing of the memory system 110) using the control information stored in the corresponding fuse block 210. In some examples, the error control fuses 215 may be located with the corresponding fuse block 210 in the fuse array 205. In some examples, the error control fuses 215 may be located in a different location in the fuse array 205.

When the memory system 110 obtains a error control circuit 220 by reading the fuse block 210, the memory system 110 may read the error control information stored in the error control fuses 215 and perform an error control operation. For example, the memory system 110 may use the error control information to determine whether the corresponding fuse block 210 contains an error (e.g., whether one or more fuses in the fuse block 310 has failed). In some examples, to perform the error control operation, the memory system 110 may use the error control circuit 220 of the fuse block 210 to generate error control information and may compare the generated error control information to the error control information stored in the error control fuses 215. If the generated error control information does not match the error control information stored in the error control fuses 215, the memory system may determine that the corresponding fuse block 210 contains an error.

In some examples (e.g., if the error control information is parity information such as a parity bit), the memory system 110 may use the error control information to detect whether a single error exists in the information stored in the fuse block 210 (e.g., with 100% accuracy for single fuse failure). In some examples (e.g., if the error control information is CRC information), the memory system 110 may use the error control information to detect whether one or more errors exist in the information stored in the fuse block 210 (e.g., with 100% accuracy for multiple fuse failures). In some examples (e.g., if the error control information is ECC information), the memory system 110 may use the error control information to detect whether one or more errors exist in the information stored in the fuse block 210. In some cases, the ECC information could be an example of a single error correction (SEC) ECC, a SEC double error detection (SECDED) ECC, or other forms of ECC code (e.g., the ECC may be configured to detect and/or correct a SBE and detect multi-bit errors (MBEs)).

In some examples, if the corresponding fuse block 210 contains the error, the memory system 110 may perform one or more additional error control operations based on detecting the error. For example, the memory system 110 may output an error flag 225 (e.g., to a user of the memory system 110 or to a host system) to indicate (e.g., to a host system) that the error is present. Additionally, or alternatively, the memory system 110 may update an error log 230 (e.g., a register) with information about the detected error. The information about he detected error may be an indication of the location of the error, the type of the error (e.g., correctable error or uncorrectable error), or any combination thereof. In some examples, the memory system may update the error log 230 with the information about the detected error based on detecting a correctable error or an uncorrectable error. The host system may be configured to read the error log 230 periodically. In some cases, memory system may update the error log 230 with the information about the detected error based on detecting a correctable error or an uncorrectable error and may send the error flag 225 alerting the host system that the error log 230 includes information about the error. The host system may be configured to read the error log 230 after receiving the error flag. In some cases, memory system may include the information about the detected error in the error flag 225.

In some examples, if the error control information is ECC information, the memory system 110 may use the error control information to correct one or more errors in the fuse block 210 (e.g., as part of performing the error control operation). For example, the memory system 110 may detect an SBE and may use a SEC or SECDED ECC information correct the SBE. In some examples, the memory system 110 may detect an MBE in the fuse block 210. In some cases, the ECC information may be configured to correct some MBEs (e.g., double-bit error correction or an ability to correct a subset of double-bit errors). The memory system 110 may accordingly output the fuse information (e.g., whether corrected or uncorrected) via a fuse readout 235 including a corrected operating parameter. In some examples, the memory system 110 may output the error flag 225 and/or update the error log 230 for both of the detected SBEs and the detected MBEs (e.g., for correctable errors and uncorrectable errors), or may output the error flag 225 and/or update the error log 230 for the detected MBEs (e.g., for uncorrectable errors only).

The control information (e.g., the operating parameter) may be output from the fuse array. The memory system 110 may operate the memory device in accordance with the control information (e.g., the operating parameter) after performing the error control operation (e.g., using the error control circuit 220 and/or the fuse readout 235).

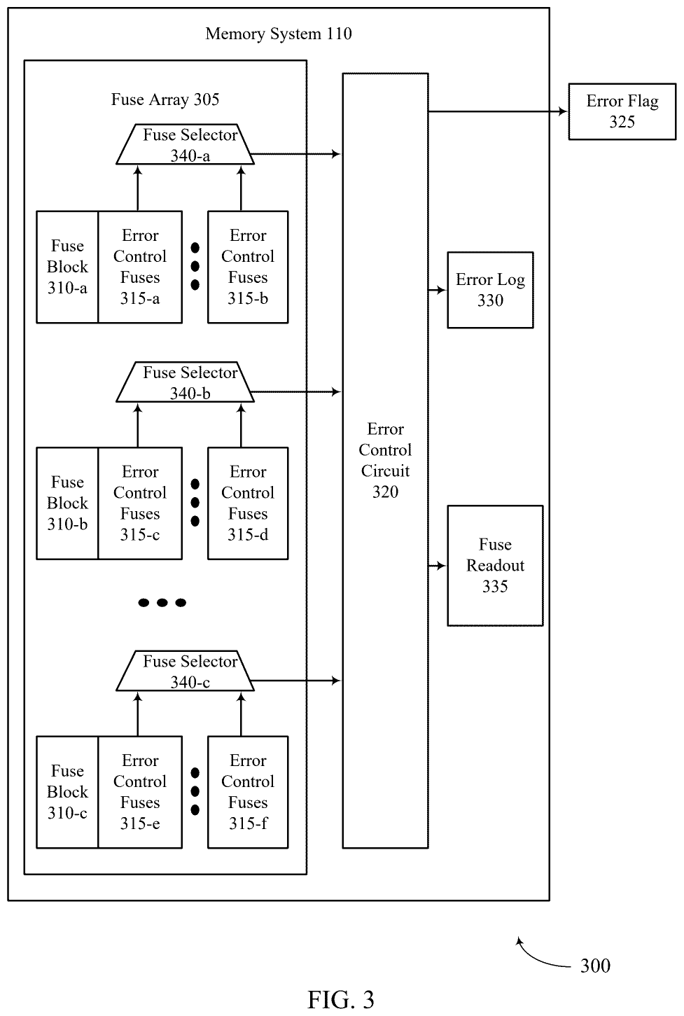

FIG. 3 shows an example of a memory system diagram 300 that supports error control for fuse arrays in accordance with examples as disclosed herein. The memory system diagram 300 may implement or may be implemented by aspects of the system 100 or the memory system diagram 200. For example, the memory system diagram 300 may be implemented in the memory system 110 as described with reference to FIG. 1. The techniques described in the context of the memory system diagram 300 may enable a memory system 110 to detect and/or correct errors in a fuse array 305.

In some examples, a fuse array 305 may enable a user to perform PPR by modifying a fuse block 310. Post-Package Repair [PPR] in memory systems may refer to the process of fixing defects or malfunctions in memory devices after they have been packaged. Sometimes errors can occur in a memory system, and these issues may not be detected until after the device has been fully assembled. PPR allows these defects to be repaired without having to disassemble the entire device, which can save time and resources. In some examples, the memory system may include redundant resources (e.g., spare resources). If certain errors are detected in some physical components, the memory system may replace (e.g., logically) the defective component with one of the redundant components. For example, a memory system may “unmap” a defective component and instead may “map” logical resources to a redundant component.

For example, if one or more fuses of the fuse block 310 have failed, the user may use a redundant or spare set of fuses appended to the fuse block 310 to replace the one or more failed fuses. That is, information stored in the spare fuses may be rerouted to replace the information stored in the one or more failed fuses. In such examples, a set of error control fuses 315 with error control information generated based on an unmodified fuse block 310 (e.g., as described with reference to FIG. 2) may not contain correct error control information for the “repaired” fuse block 310.

Accordingly, if the fuse array 205 is to support PPR for fuse blocks 310, the fuse array 305 may also include multiple sets of error control fuses 315 corresponding to each fuse block 310 to support PPR for the sets of error control fuses 315. In some cases, the memory system may support an additional set of error control fuses 315 for each PPR resource available for the user to repair the fuse block 310. For example, a fuse block 310-a may correspond to error control fuses 315-a through error control fuses 315-b, a fuse block 310-b may correspond to error control fuses 315-c through error control fuses 315-d, and a fuse block 310-c may correspond to error control fuses 315-e through error control fuses 315-f.

If the user modifies a fuse block 310 (e.g., using PPR), the memory system 110 may generate new error control information based on the modified fuse block 310. The memory system 110 may store the new error control information in a next set of error control fuses 315 (e.g., a set of error control fuses 315 that are subsequent to a set of error control fuses 315 including error control information for the unmodified fuse block 310). If the user modifies the fuse block 310 one or more additional times, the memory system 110 may generate a corresponding one or more additional error control information and store the additional error control information via one or more additional subsequent sets of error control fuses 315.

The fuse array 305 may accordingly include a fuse selector 340 corresponding to each fuse block 310. For example, the fuse block 310-a may include a fuse selector 340-a, the fuse block 310-b may include a fuse selector 340-b, and the fuse block 310-c may include a fuse selector 340-c. The memory system 110 may therefore use the fuse selector 340 to select which set of error control fuses 315 to use to perform error control on a fuse block 310. In some cases, the fuse selector 340 may be an example of a multiplexor coupled with a set of redundant error control fuses 315. In such cases, a PPR procedure for the error control fuses 315 may be as simple as changing the input to the multiplexor to cause the fuse selector 340 to output a different set of data to the error control circuit 320. For example, if the information stored in fuse block 310 is unmodified, the fuse selector 340-a may output error control information stored in a first set of error control fuses 315. If the fuse block 310 has been modified one time (e.g., via PPR), the fuse selector 340-a may output error control information stored in a second set of error control fuses 315.

In some examples, the fuse selector 340 may be protected by the error control fuses 315. For example, the error control information in the error control fuses 315 may be computed based on the corresponding information stored in the fuse block 310 and based on the fuse selector 340.

The memory system 110 may accordingly obtain an error control circuit 320 by reading the fuses of the fuse block 310. The memory system 110 may use the error control information (e.g., CRC information, parity information, ECC information) stored in the selected set of error control fuses 325 to detect one or more errors and may output an error flag 325 and/or update an error log 330, as described with reference to FIG. 2. In some examples, if the error control information is ECC information, the memory system 110 may use the ECC information to obtain information to output (e.g., whether correcting the information for correctable errors or passing through information with errors for uncorrectable errors) via a fuse readout 335 as described with reference to FIG. 2.

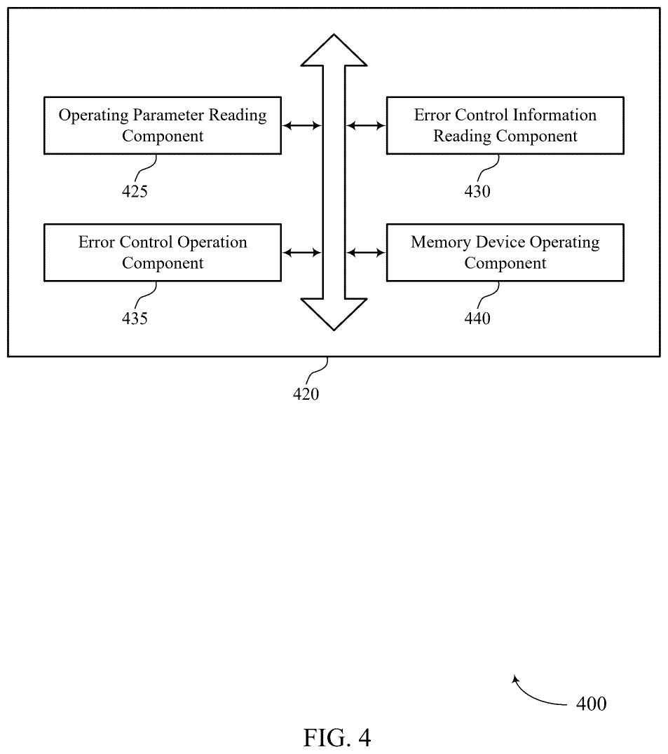

FIG. 4 shows a block diagram 400 of a memory system 420 that supports error control for fuse arrays in accordance with examples as disclosed herein. The memory system 420 may be an example of aspects of a memory system as described with reference to FIGS. 1 through 3. The memory system 420, or various components thereof, may be an example of means for performing various aspects of error control for fuse arrays as described herein. For example, the memory system 420 may include an operating parameter reading component 425, an error control information reading component 430, an error control operation component 435, a memory device operating component 440, or any combination thereof. Each of these components, or components of subcomponents thereof (e.g., one or more processors, one or more memories), may communicate, directly or indirectly, with one another (e.g., via one or more buses).

The operating parameter reading component 425 may be configured as or otherwise support a means for reading an operating parameter stored in an array of fuses. The error control information reading component 430 may be configured as or otherwise support a means for reading error control information stored in the array of fuses, the error control information associated with the operating parameter. The error control operation component 435 may be configured as or otherwise support a means for performing an error control operation on the operating parameter using the error control information based at least in part on reading the operating parameter and the error control information. The memory device operating component 440 may be configured as or otherwise support a means for operating a memory device using the operating parameter based at least in part on performing the error control operation.

In some examples, to support performing the error control operation, the error control operation component 435 may be configured as or otherwise support a means for detecting an error associated with the array of fuses based at least in part on the error control information. In some examples, to support performing the error control operation, the error control operation component 435 may be configured as or otherwise support a means for outputting an error flag in accordance with detecting the error.

In some examples, to support detecting the error, the error control operation component 435 may be configured as or otherwise support a means for detecting that a first fuse of the array of fuses has failed based at least in part on parity information stored in the array of fuses, where the error control information includes the parity information.

In some examples, to support detecting the error, the error control operation component 435 may be configured as or otherwise support a means for detecting that one or more fuses of the array of fuses have failed based at least in part on CRC information stored in the array of fuses, where the error control information includes the CRC information.

In some examples, to support detecting the error, the error control operation component 435 may be configured as or otherwise support a means for detecting that one or more fuses of the array of fuses have failed based at least in part on ECC information stored in the array of fuses, where the error control information includes the ECC information.

In some examples, to support performing the error control operation, the error control operation component 435 may be configured as or otherwise support a means for correcting one or more errors included in the operating parameter using an error correction operation based at least in part on the ECC information. In some examples, to support performing the error control operation, the error control operation component 435 may be configured as or otherwise support a means for outputting a corrected operating parameter, where operating the memory device is in accordance with the corrected operating parameter.

In some examples, the error control operation component 435 may be configured as or otherwise support a means for updating a register that stores information associated with errors detected by the error control operation.

In some examples, the error control information reading component 430 may be configured as or otherwise support a means for selecting a first set of fuses of the array of fuses based at least in part on a post package repair operation performed on the array of fuses, where the error control information is stored in the first set of fuses.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

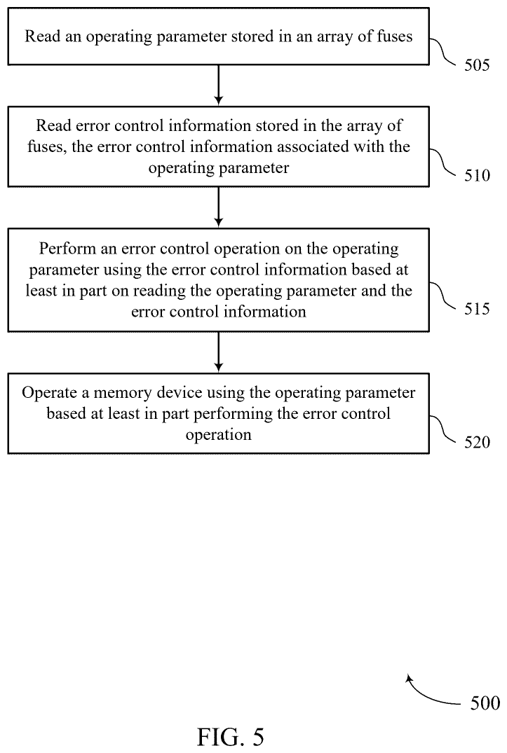

FIG. 5 shows a flowchart illustrating a method 500 that supports error control for fuse arrays in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include reading an operating parameter stored in an array of fuses. In some examples, aspects of the operations of 505 may be performed by an operating parameter reading component 425 as described with reference to FIG. 4.

At 510, the method may include reading error control information stored in the array of fuses, the error control information associated with the operating parameter. In some examples, aspects of the operations of 510 may be performed by an error control information reading component 430 as described with reference to FIG. 4.

At 515, the method may include performing an error control operation on the operating parameter using the error control information based at least in part on reading the operating parameter and the error control information. In some examples, aspects of the operations of 515 may be performed by an error control operation component 435 as described with reference to FIG. 4.

At 520, the method may include operating a memory device using the operating parameter based at least in part on performing the error control operation. In some examples, aspects of the operations of 520 may be performed by a memory device operating component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for reading an operating parameter stored in an array of fuses; reading error control information stored in the array of fuses, the error control information associated with the operating parameter; performing an error control operation on the operating parameter using the error control information based at least in part on reading the operating parameter and the error control information; and operating a memory device using the operating parameter based at least in part on performing the error control operation.

Aspect 2: The method, apparatus, or non-transitory computer-readable medium of aspect 1, where performing the error control operation includes operations, features, circuitry, logic, means, or instructions, or any combination thereof for detecting an error associated with the array of fuses based at least in part on the error control information and outputting an error flag in accordance with detecting the error.

Aspect 3: The method, apparatus, or non-transitory computer-readable medium of aspect 2, where detecting the error includes operations, features, circuitry, logic, means, or instructions, or any combination thereof for detecting that a first fuse of the array of fuses has failed based at least in part on parity information stored in the array of fuses, where the error control information includes the parity information.

Aspect 4: The method, apparatus, or non-transitory computer-readable medium of any of aspects 2 through 3, where detecting the error includes operations, features, circuitry, logic, means, or instructions, or any combination thereof for detecting that one or more fuses of the array of fuses have failed based at least in part on CRC information stored in the array of fuses, where the error control information includes the CRC information.

Aspect 5: The method, apparatus, or non-transitory computer-readable medium of any of aspects 2 through 4, where detecting the error includes operations, features, circuitry, logic, means, or instructions, or any combination thereof for detecting that one or more fuses of the array of fuses have failed based at least in part on ECC information stored in the array of fuses, where the error control information includes the ECC information.

Aspect 6: The method, apparatus, or non-transitory computer-readable medium of aspect 5, where performing the error control operation further includes operations, features, circuitry, logic, means, or instructions, or any combination thereof for correcting one or more errors included in the operating parameter using an error correction operation based at least in part on the ECC information and outputting a corrected operating parameter, where operating the memory device is in accordance with the corrected operating parameter.

Aspect 7: The method, apparatus, or non-transitory computer-readable medium of any of aspects 1 through 6, further including operations, features, circuitry, logic, means, or instructions, or any combination thereof for updating a register that stores information associated with errors detected by the error control operation.

Aspect 8: The method, apparatus, or non-transitory computer-readable medium of any of aspects 1 through 7, further including operations, features, circuitry, logic, means, or instructions, or any combination thereof for selecting a first set of fuses of the array of fuses based at least in part on a post package repair operation performed on the array of fuses, where the error control information is stored in the first set of fuses.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
reading an operating parameter stored in an array of fuses;
reading error control information stored in the array of fuses, the error control information associated with the operating parameter;
performing an error control operation on the operating parameter using the error control information based at least in part on reading the operating parameter and the error control information; and
operating a memory device using the operating parameter based at least in part on performing the error control operation.

2. The method of claim 1, wherein performing the error control operation comprises:
detecting an error associated with the array of fuses based at least in part on the error control information; and
outputting an error flag in accordance with detecting the error.

3. The method of claim 2, wherein detecting the error comprises:
detecting that a first fuse of the array of fuses has failed based at least in part on parity information stored in the array of fuses, wherein the error control information comprises the parity information.

4. The method of claim 2, wherein detecting the error comprises:
detecting that one or more fuses of the array of fuses have failed based at least in part on cyclic redundancy check information stored in the array of fuses, wherein the error control information comprises the cyclic redundancy check information.

5. The method of claim 2, wherein detecting the error comprises:
detecting that one or more fuses of the array of fuses have failed based at least in part on error correction code information stored in the array of fuses, wherein the error control information comprises the error correction code information.

6. The method of claim 5, wherein performing the error control operation further comprises:
correcting one or more errors included in the operating parameter using an error correction operation based at least in part on the error correction code information; and
outputting a corrected operating parameter, wherein operating the memory device is in accordance with the corrected operating parameter.

7. The method of claim 1, further comprising:
updating a register that stores information associated with errors detected by the error control operation.

8. The method of claim 1, further comprising:
selecting a first set of fuses of the array of fuses based at least in part on a post package repair operation performed on the array of fuses, wherein the error control information is stored in the first set of fuses.

9. A non-transitory computer-readable medium storing code, the code comprising instructions executable by one or more processors to:
read an operating parameter stored in an array of fuses;
read error control information stored in the array of fuses, the error control information associated with the operating parameter;
perform an error control operation on the operating parameter using the error control information based at least in part on reading the operating parameter and the error control information; and
operate a memory device using the operating parameter based at least in part on performing the error control operation.

10. The non-transitory computer-readable medium of claim 9, wherein the instructions to perform the error control operation are executable by the one or more processors to:
detect an error associated with the array of fuses based at least in part on the error control information; and
output an error flag in accordance with detecting the error.

11. The non-transitory computer-readable medium of claim 10, wherein the instructions to detect the error are executable by the one or more processors to:
detect that a first fuse of the array of fuses has failed based at least in part on parity information stored in the array of fuses, wherein the error control information comprises the parity information.

12. The non-transitory computer-readable medium of claim 10, wherein the instructions to detect the error are executable by the one or more processors to:
detect that one or more fuses of the array of fuses have failed based at least in part on cyclic redundancy check information stored in the array of fuses, wherein the error control information comprises the cyclic redundancy check information.

13. The non-transitory computer-readable medium of claim 10, wherein the instructions to detect the error are executable by the one or more processors to:
detect that one or more fuses of the array of fuses have failed based at least in part on error correction code information stored in the array of fuses, wherein the error control information comprises the error correction code information.

14. The non-transitory computer-readable medium of claim 13, wherein the instructions to perform the error control operation are further executable by the one or more processors to:
correct one or more errors included in the operating parameter using an error correction operation based at least in part on the error correction code information; and
output a corrected operating parameter, wherein operating the memory device is in accordance with the corrected operating parameter.

15. The non-transitory computer-readable medium of claim 9, wherein the instructions are further executable by the one or more processors to:
update a register that stores information associated with errors detected by the error control operation.

16. The non-transitory computer-readable medium of claim 9, wherein the instructions are further executable by the one or more processors to:
select a first set of fuses of the array of fuses based at least in part on a post package repair operation performed on the array of fuses, wherein the error control information is stored in the first set of fuses.

17. An apparatus, comprising:
processing circuitry associated with one or more memory devices and configured to cause the apparatus to:
read an operating parameter stored in an array of fuses;
read error control information stored in the array of fuses, the error control information associated with the operating parameter;
perform an error control operation on the operating parameter using the error control information based at least in part on reading the operating parameter and the error control information; and
operate a memory device using the operating parameter based at least in part on performing the error control operation.

18. The apparatus of claim 17, wherein performing the error control operation comprises the processing circuitry configured to cause the apparatus to:
detect an error associated with the array of fuses based at least in part on the error control information; and
output an error flag in accordance with detecting the error.

19. The apparatus of claim 18, wherein detecting the error comprises the processing circuitry configured to cause the apparatus to:
detect that a first fuse of the array of fuses has failed based at least in part on parity information stored in the array of fuses, wherein the error control information comprises the parity information.

20. The apparatus of claim 18, wherein detecting the error comprises the processing circuitry configured to cause the apparatus to:
detect that one or more fuses of the array of fuses have failed based at least in part on cyclic redundancy check information stored in the array of fuses, wherein the error control information comprises the cyclic redundancy check information.

21. The apparatus of claim 18, wherein detecting the error comprises the processing circuitry configured to cause the apparatus to:
detect that one or more fuses of the array of fuses have failed based at least in part on error correction code information stored in the array of fuses, wherein the error control information comprises the error correction code information.

22. The apparatus of claim 21, wherein performing the error control operation further comprises the processing circuitry configured to cause the apparatus to:
correct one or more errors included in the operating parameter using an error correction operation based at least in part on the error correction code information; and
output a corrected operating parameter, wherein operating the memory device is in accordance with the corrected operating parameter.

23. The apparatus of claim 17, wherein the processing circuitry is further configured to cause the apparatus to:
update a register that stores information associated with errors detected by the error control operation.

24. The apparatus of claim 17, wherein the processing circuitry is further configured to cause the apparatus to:
select a first set of fuses of the array of fuses based at least in part on a post package repair operation performed on the array of fuses, wherein the error control information is stored in the first set of fuses.
